(19) United States
(12) Patent Application Publication
(10) Pub. No.: US 2013/0084428 A1
(43) Pub. Date: Apr. 4, 2013

(54) MODIFIED POLYMER SUBSTRATE AND METHOD FOR PRODUCING THE SAME, AND SURFACE TREATMENT AGENT

(71) Applicant: TOKAI RUBBER INDUSTRIES, LTD., Komaki-shi (JP)

(72) Inventors: Yousuke Hayashi, Komaki-shi (JP); Shuichi Egawa, Komaki-shi (JP)

(73) Assignee: TOKAI RUBBER INDUSTRIES, LTD., Komaki-shi (JP)

(21) Appl. No.: 13/687,474

(22) Filed: Nov. 28, 2012

Related U.S. Application Data
(63) Continuation of application No. PCT/JP2011/068537, filed on Aug. 16, 2011.

(30) Foreign Application Priority Data
Aug. 19, 2010 (JP) 2010-183871
Dec. 16, 2010 (JP) 2010-279996

(51) Int. Cl. C08G 77/388; C08K 5/04; C08G 73/14; C08C 19/28; C08F 236/12; C08G 18/83

(52) U.S. Cl. CPC C08G 77/388; C08F 236/12; C08G 18/837; C08G 73/14; C08C 19/28; C08K 5/04
USPC 428/141; 525/477; 525/105; 525/454; 525/424; 252/183.11

(57) ABSTRACT

To provide a modified polymer substrate that has both excellent releasability from an accretion adhering to a surface of the substrate and functions for intended use other than releasability, and to provide a method for producing the modified polymer substrate. A modified polymer substrate (1) includes a polymer substrate (2) containing an organic component having unsaturated carbon-to-carbon double bonds, and an organic group having a functional group (R¹) arranged to provide functions to a surface of the polymer substrate, wherein the organic group is bonded to the surface of the polymer substrate via an isocyanuraic acid backbone by bringing a treatment solvent (3) that contains (a) a trichloroisocyanuric acid and (b) a compound having an unsaturated carbon-to-carbon double bond and an organic group having a functional group (R¹) arranged to provide functions to the surface of the polymer substrate into contact with the surface of the polymer substrate.

### TECHNICAL FIELD

The present invention relates to a modified polymer substrate and a method for producing the same, and a surface treatment agent, and more specifically relates to a modified polymer substrate that is favorably used for a polymer substrate used for a surface of a conductive member for electrophotographic machine or an automobile wiper, and a method for producing the same, and a surface treatment agent.

### BACKGROUND ART

Conventionally, polymer products made from polymers such as a resin, rubber and an elastomer are produced in a variety of fields. Polymer substrates of the polymer products are required to have the functions for intended use on their surfaces, and each polymer substrate is sometimes required to have a plurality of functions for intended use, instead of a single function, on the surface.

For example, when an electrophotographic machine is used, toner adheres to a surface of a conductive member such as a development roller used in the electrophotographic machine; however, the toner is required not to adhere to the surface when the conductive member is left unused for the long term. In addition, a phenomenon called filming, in which the toner accumulates on the surface of the roller, is liable to occur when the electrophotographic machine keeps being used; however, this phenomenon should be prevented, so that the surface is required to have a small coefficient of friction. In addition, the surface is required to electrically charge the toner properly by friction with the toner.

Thus, a method is generally used, in which functions for intended use are provided on the surface of the polymer substrate. Examples of the method include a method in which a function layer made of a paint containing a compound for providing functions for intended use is formed on the surface of the polymer substrate. In this method, however, if the physical properties of the material of the polymer substrate are different significantly from those of the material of the function layer, the physical properties such as hardness of the surface of the polymer substrate could change considerably, so that adjustment of the functions to be provided is sometimes difficult.

There is another method for modifying a surface of a polymer substrate with the use of a surface treatment agent. For example, PTL 1 discloses a method for modifying a surface of a polymer substrate that is mainly made from urethane rubber or silicone rubber with the use of a surface treatment agent containing isocyanate. However, the method of PTL 1 is effective only for a polymer substrate having specific functional groups such as hydroxyl groups and amino groups that are capable of reacting with isocyanate groups that are used as reactive groups in the surface treatment agent, and may not be effective at modifying a surface of a polymer substrate that has unsaturated carbon-to-carbon double bonds while not having the specific functional groups. Therefore, the method disclosed in PTL 1 is not appropriate in modifying the surface of the polymer substrate having the unsaturated carbon-to-carbon double bonds.

Methods for modifying a surface of a polymer substrate having unsaturated carbon-to-carbon double bonds are disclosed in PTLs 2 and 3, for example. PTL 2 discloses a method in which (A) a compound having —CONX— bonds in its molecules (X: a halogen atom) and (B) BF₃ are brought into contact with the surface of a rubber layer containing rubber having unsaturated bonds, the rubber layer being disposed on an outermost layer of a roller for electrophotographic machine, and thus halogen atoms originated in the (A) compound and fluorine atoms originated in the (B) compound are introduced to the surface. PTL 3 discloses a method in which surface treatment is performed on vulcanized rubber with the use of a solution in which an organic activated halogen compound having functional groups that are expressed in a rational formula —CONX— (X: a halogen atom) is dissolved.

### CITATION LIST

### Patent Literature

PTL 1: Patent JP 3444391
PTL 2: Patent JP 2007-256709
PTL 3: Patent JP S60-108438

### SUMMARY OF INVENTION

### Technical Problem

However, while the method disclosed in PTL 2 allows the surface of the rubber layer to have improved releasability from an external additive of toner adhering to the surface of the rubber layer, the surface has a small effect of decreasing a coefficient of friction. Thus, the method only provides the limited specific function to the surface of the rubber layer. In addition, when the method disclosed in PTL 3 is performed on a polymer substrate of a conductive member for electrophotographic machine, while the method allows a surface of the polymer substrate to have improved releasability from toner adhering to the surface, the surface has an insufficient effect of decreasing a coefficient of friction. Thus, similarly to the method disclosed in PTL 2, the method disclosed in PTL 3 only provides the limited specific function to the surface of the rubber layer.

As described above, the conventional surface treatment methods cannot provide a plurality of functions at the same time, so that it is difficult to provide a plurality of functions desired for intended use to a surface of a polymer substrate having unsaturated carbon-to-carbon double bonds.

An object of the present invention is to provide a modified polymer substrate that has both excellent releasability from an accretion adhering to a surface of the substrate and functions for intended use other than releasability, and to provide a method for producing the modified polymer substrate. Another object of the present invention is to provide a surface treatment agent that is capable of providing both excellent releasability from an accretion adhering to a surface of a polymer substrate and functions for intended use other than releasability to the polymer substrate having unsaturated carbon-to-carbon double bonds.

### Solution to Problem

In order to solve the problems described above, a modified polymer substrate of the present invention includes a polymer substrate, and an organic group having a functional group arranged to provide functions to a surface of the polymer substrate, wherein the organic group is bonded to the surface of the polymer substrate via an isocyanuric acid backbone.

It is preferable that the functional group defines one or more than one kind of functional group selected from the group consisting of a silicone group, a fluorine-containing group, a perfluoroalkyl group, an ester group, an amide group, an imide group, an ether group, an aryl group, an azo group, a diazo group, a nitro group, an epoxy group, a carbonyl group, a heterocyclic group, a mesoionic group, a halogen group, an amino group, an imino group, an alkyl group, a sulfonic acid group, a hydroxyl group, an acyl group, a formyl group, a carboxylic acid group, a urea group, a urethane group, and a cyano group.

It is preferable that the organic group defines a group originated in an organic compound having an unsaturated carbon-to-carbon double bond.

It is preferable that the surface of the polymer substrate has asperities.

In another aspect of the present invention, a method for producing a modified polymer substrate of the present invention includes the step of bringing a treatment solvent into contact with a surface of a polymer substrate containing an organic component having unsaturated carbon-to-carbon double bonds, wherein the treatment solvent contains a component (a) that defines a trichloroisocyanuric acid, and a component (b) that defines a compound that has an unsaturated carbon-to-carbon double bond and an organic group having a functional group arranged to provide functions to the surface of the polymer substrate.

Yet, in another aspect of the present invention, a surface treatment agent of the present invention that is brought into contact with a surface of a polymer substrate containing an organic component having unsaturated carbon-to-carbon double bonds, the surface treatment agent containing a component (a) that defines a trichloroisocyanuric acid, and a component (b) that defines a compound that has an unsaturated carbon-to-carbon double bond and an organic group having a functional group arranged to provide functions to the surface of the polymer substrate.

### Advantageous Effects of Invention

In the modified polymer substrate of the present invention, because the organic group having the functional group arranged to provide functions to the surface of the polymer substrate is bonded to the surface of the polymer substrate via the isocyanuric acid backbone, the modified polymer substrate can be provided with both excellent releasability from an accretion adhering to the surface of the polymer substrate and functions for intended use other than releasability.

In addition, the method for producing the modified polymer substrate of the present invention can provide both excellent releasability from an accretion adhering to the surface of the polymer substrate and functions for intended use other than releasability to the surface of the polymer substrate containing the organic component having the unsaturated carbon-to-carbon double bonds, whereby a modified polymer substrate can be provided, which has both excellent releasability from an accretion adhering to the surface of the polymer substrate and functions for intended use other than releasability.

In addition, because the surface treatment agent of the present invention contains the component (a) that defines the trichloroisocyanuric acid, and the component (b) that defines the compound that has the unsaturated carbon-to-carbon double bond and the organic group having the functional group arranged to provide functions to the surface of the polymer substrate, both excellent releasability from an accretion adhering to the surface of the polymer substrate and functions for intended use other than releasability can be provided to the surface of the polymer substrate containing the organic component having the unsaturated carbon-to-carbon double bonds.

### BRIEF DESCRIPTION OF DRAWINGS

FIGS. 1A and 1B are cross-sectional views showing conductive rollers for electrophotographic machine in circumferential directions, which are shown as examples of a modified polymer substrate of the present invention.

FIG. 1A shows a conductive roller with a single layer structure, and FIG. 1B shows a conductive roller with a double layer structure.

FIG. 2 is a cross-sectional view showing a conductive belt for electrophotographic machine, which is shown as an example of a modified polymer substrate of the present invention.

FIGS. 3A, 3B and 3C are schematic views showing examples of the state of a surface of a modified polymer substrate of the present invention.

FIGS. 4A, 4B and 4C are schematic views showing a process of surface treatment performed on a polymer substrate.

### DESCRIPTION OF EMBODIMENTS

A detailed description of a modified polymer substrate of the present invention will now be provided. The modified polymer substrate of the present invention has a structure that organic groups each of which has a specific functional group are bonded to a surface of a polymer substrate via isocyanuric acid backbones.

The modified polymer substrate of the present invention can be used for polymer substrates of various polymer products. In particular, the modified polymer substrate of the present invention can be used favorably for polymer substrates of polymer products, surfaces of which are required to have a plurality of functions, not a single function. For example, the modified polymer substrate of the present invention is used for a conductive member for electrophotographic machine such as a conductive roller for electrophotographic machine (e.g., a development roller, a charging roller, a transfer roller, a toner supply roller), a conductive belt for electrophotographic machine (e.g., a transfer belt) and a conductive blade for electrophotographic machine (e.g. a cleaning blade), and an automobile wiper. In addition, the modified polymer substrate of the present invention is used for a printing roller, a papermaking roller, a conveying roller and a laminating roller.

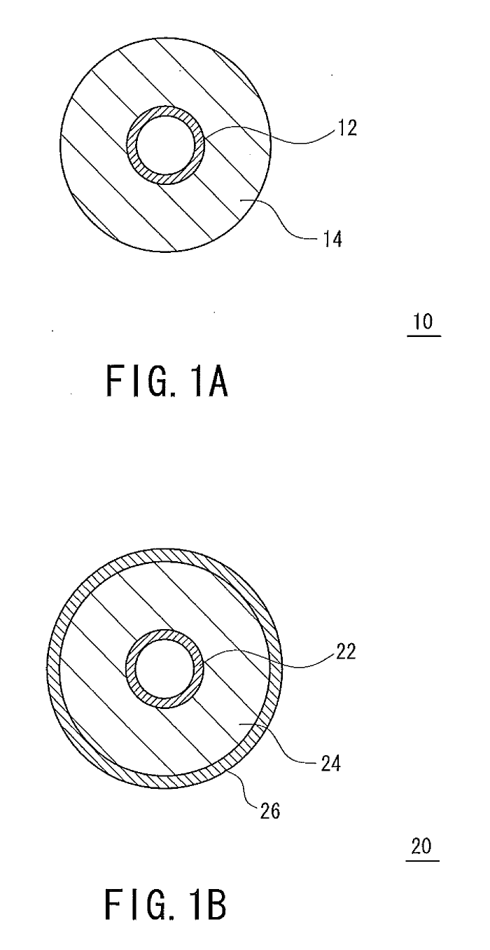

For example, if used for a conductive roller for electrophotographic machine, the modified polymer substrate of the present invention is favorably used as an outermost layer of the roller. A configuration of the conductive roller for electrophotographic machine is shown in FIG. 1A, where a conductive roller 10 includes an axis member 12, and an elastic layer 14 of a single layer that is formed around the axis member 12. Another configuration of the conductive roller for electrophotographic machine is shown in FIG. 1B, where a conductive roller 20 includes an axis member 22, and elastic layers 24 and 26 of two layers that are formed around the axis member 22. The elastic layers around the axis member may be three or more layers. In the configuration shown in FIG. 1B, the inner elastic layer 24 defines a base layer, and the outer elastic layer 26 defines a resistance adjustment layer. In the configuration shown in FIG. 1A, the elastic layer 14 defines an outermost layer, so that the modified polymer substrate of the present invention is favorably used as the elastic layer 14. In the configuration shown in FIG. 1B, the outer elastic layer 26 defines an outermost layer, so that the modified polymer substrate of the present invention is favorably used as the outer elastic layer 26.

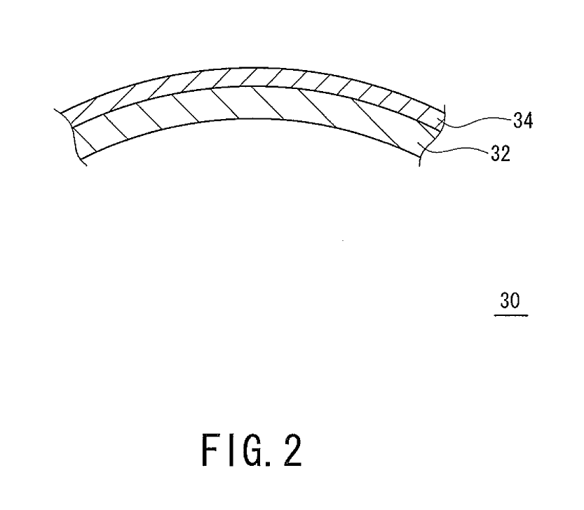

A configuration of a conductive belt for electrophotographic machine where the modified polymer substrate of the present invention is used is shown in FIG. 2, where a conductive belt 30 includes an inner elastic layer 32 that defines a base layer, and an outer elastic layer 34 that defines a surface layer. The modified polymer substrate of the present invention is favorably used as the outer elastic layer 34.

The polymer substrate may be made from any one of rubber, a resin and an elastomer. Specific examples thereof include natural rubber (NR), isoprene rubber (IR), butadiene rubber (BR), acrylonitrile-butadiene rubber (NBR), styrene-butadiene rubber (SBR), chloroprene rubber (CR), butyl rubber (IIR), ethylene-propylene diene rubber (EPDM), acrylic rubber (ACM), fluororubber (FKM), chlorosulfonated polyethylene (CSM), hydrinrubber (e.g., CO, ECO), silicone rubber (Q), urethane (U), an ethylene-vinyl acetate copolymer (EVA), a polyethylene resin, an epoxy resin, and polyamide.

The specific functional group is arranged to provide specific functions to the surface of the polymer substrate. Examples of the functional group include a silicone group, a fluorine-containing group, a perfluoroalkyl group, an ester group, an amide group, an imide group, an ether group, an aryl group, an azo group, a diazo group, a nitro group, an epoxy group, a carbonyl group, a heterocyclic group, a mesoionic group, a halogen group, an amino group, an imino group, an alkyl group, a sulfonic acid group, a hydroxyl group, an acyl group, a formyl group, a carboxylic acid group, a urea group, a urethane group, and a cyano group. The organic group may have one kind of functional group, or a plurality of functional groups, which are selected from the functional groups described above.

Examples of the heterocyclic group include a pyridyl group, an imidazole group and an oxazole group. Examples of the mesoionic group include a sydnone group and a munchnone group.

When silicone groups or fluorine-containing groups (in particular, perfluoroalkyl groups) are contained as the specific functional groups in the organic groups bonded to the surface of the polymer substrate, e.g., the conductive member for electrophotographic machine, the modified polymer substrate is provided with both excellent releasability from an accretion such as toner and an external additive of toner adhering to the surface of the polymer substrate, and a function of decreasing a coefficient of friction. In addition, the adhesion of the surface of the polymer substrate can be minimized, and the components in the substrate can be prevented from bleeding.

When amide groups or ester groups are contained as the functional groups in the organic groups bonded to the surface of the polymer substrate, e.g., the conductive member for electrophotographic machine, the modified polymer substrate is provided with both excellent releasability from an accretion such as toner and an external additive of toner adhering to the surface of the polymer substrate, and an increased toner charging property.

When alkyl ether such as propylene glycol is contained as the functional groups in the organic groups bonded to the surface of the polymer substrate, e.g., the conductive member for electrophotographic machine, the modified polymer substrate is provided with both excellent releasability from an accretion such as toner and an external additive of toner adhering to the surface of the polymer substrate, and an antistatic property with which electrical resistance of the surface is reduced.

Also when functional groups other than the specific functional groups described above are contained in the organic groups bonded to the surface of the polymer substrate, e.g., the conductive member for electrophotographic machine, the surface of the polymer substrate is provided with functions specific to the functional groups in addition to excellent releasability from an accretion such as toner and an external additive of toner adhering to the surface of the polymer substrate.

The organic groups having the specific functional groups are each boned to N atoms of the isocyanuric acid backbones. The isocyanuric acid backbones are bonded to the polymer substrate by their N atoms. Because one isocyanuric acid backbone has three N atoms, one organic group having the specific functional group may be bonded to one isocyanuric acid backbone, or two organic groups having the specific functional groups may be bonded to one isocyanuric acid backbone. When two organic groups having the specific functional groups are bonded to one isocyanuric acid backbone, the isocyanuric acid backbone is bonded to the polymer substrate by one N atom. When one organic group having the specific functional group is bonded to one isocyanuric acid backbone, the isocyanuric acid backbone is bonded to the polymer substrate by one N atom or two N atoms.

Each organic group having the specific functional group is preferably a group originated in an organic compound having an unsaturated carbon-to-carbon double bond. In the organic compound, the specific functional group may be directly bonded to the carbon atom of the unsaturated carbon-to-carbon double bond, or may be indirectly bonded to the carbon atom of the unsaturated carbon-to-carbon double bond via another structural site such as a carbon chain. The specific functional group is directly or indirectly bonded to one carbon atom of a carbon-to-carbon single bond that is originated in the unsaturated carbon-to-carbon double bond of the organic compound, while the N atom of the isocyanuric acid backbone is bonded to the other carbon atom as described above.

Examples of the organic compound include organic compounds expressed in chemical formulas 1 to 4 as follows.

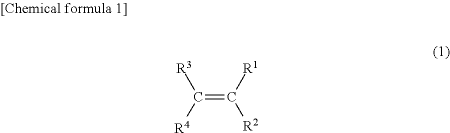

In chemical formula 1, R¹ defines —X²—X¹ or —X¹, where X¹ defines the specific functional group, preferably a silicone group or a fluorine-containing group, and X² defines an ester group (—C(O)O—), an ether group (—O—), a carbonyl group (—CO—), a urethane group (—NH—C(O)O—), or an amide group (—NH—CO—), preferably an ester group. R² to R⁴ may be hydrogen groups or alkyl groups, or may be same groups as R¹, or may be groups having specific functional groups other than R¹. R² to R⁴ are preferably hydrogen groups or alkyl groups in view of stability, and more preferably hydrogen groups. In addition, R¹ to R⁴ may be groups different from one another, or some or all of them may be groups of a same kind.

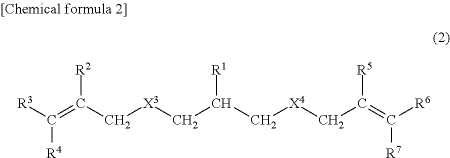

In chemical formula 2, R¹ defines or —X²—X¹, or —X¹, where X¹ defines the specific functional group, preferably a silicone group or a fluorine-containing group, and X² defines an ester group, an ether group, a carbonyl group, a urethane group or an amide group, preferably an ester group. R² to R⁷ may be hydrogen groups or alkyl groups, or may be same groups as R¹, or may be groups having specific functional groups other than R¹. R² to R⁷ are preferably hydrogen groups or alkyl groups in view of stability, and more preferably hydrogen groups. In addition, R¹ to R⁷ may be groups different from one another, or some or all of them may be groups of a same kind. X³ to X⁴ define ester groups, ether groups, carbonyl groups, urethane groups or amide groups, preferably ester groups. X³ to X⁴ may have structures different from each other, or may have structures of a same kind.

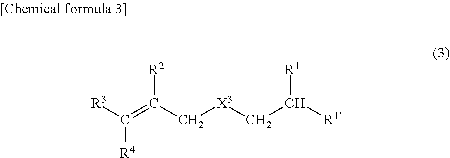

In chemical formula 3, R¹ and R^{1′} define —X²—X¹ or —X¹, where X¹ defines the specific functional group, preferably a silicone group or a fluorine-containing group, and X² defines an ester group, an ether group, a carbonyl group, a urethane group or an amide group, preferably an ester group. R² to R⁴ may be hydrogen groups or alkyl groups, or may be same groups as R¹, or may be groups having specific functional groups other than R² to R⁴ are preferably hydrogen groups or alkyl groups in view of stability, and more preferably hydrogen groups. In addition, R¹ to R⁴ may be groups different from one another, or some or all of them may be groups of a same kind. X³ defines an ester group, an ether group, a carbonyl group, a urethane group or an amide group, preferably an ester group.

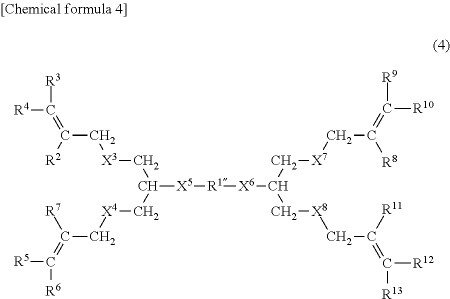

In chemical formula 4, R^{1″} define —X²—X¹—X¹ or —X¹—, where X¹ defines the specific functional group, preferably a silicone group or a fluorine-containing group, and X² defines an ester group, an ether group, a carbonyl group, a urethane group or an amide group, preferably an ester group. R² to R¹³ may be hydrogen groups or alkyl groups, or may be same groups as R¹, or may be groups having specific functional groups other than R¹. R² to R¹³ are preferably hydrogen groups or alkyl groups in view of stability, and more preferably hydrogen groups. In addition, R¹ to R¹³ may be groups different from one another, or some or all of them may be groups of a same kind. X³ to X⁸ define ester groups, ether groups, carbonyl groups, urethane groups or amide groups, preferably ester groups. X³ to X⁸ may have structures different from one another, or some or all of them may have structures of a same kind.

In particular, favorable examples of the organic compound of chemical formula 1 include organic compounds of chemical formulas 5 to 6 to be described below in view of stability (in particular, an organic compound having a silicone group or a fluorine-containing group as the specific functional group is preferable).

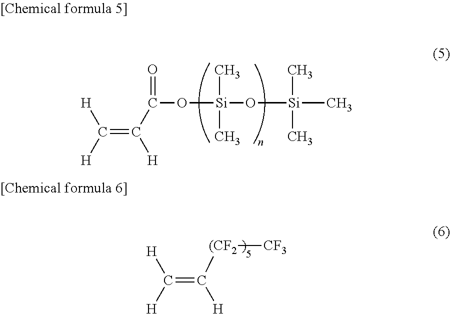

In chemical formulas 5 to 6, n is a positive integer.

In addition, specific examples of the organic compound of chemical formula 1 include organic compounds of chemical formulas 7 to 9 to be described below in addition to the organic compounds of chemical formulas 5 to 6.

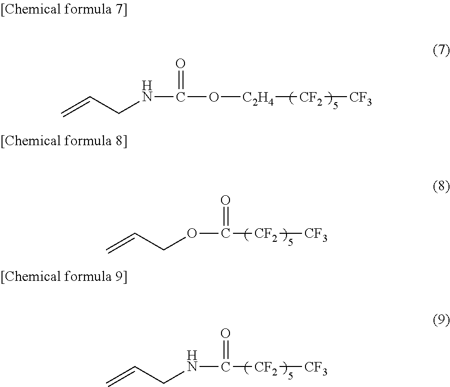

In particular, favorable examples of the organic compounds of chemical formulas 2 to 4 include organic compounds of chemical formulas 10 to 13 to be described below in view of stability (in particular, an organic compound having a silicone group or a fluorine-containing group as the specific functional group is preferable).

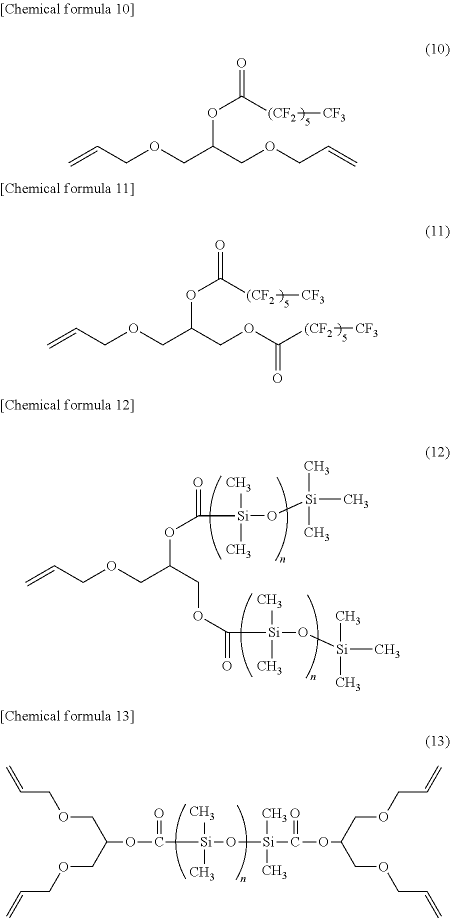

In chemical formulas 10 to 13, n is a positive integer.

As conventionally known, an ester group is obtained by a condensation reaction between a compound having a carboxylic acid group and a compound having a hydroxyl group, for example. An amide group is obtained by a condensation reaction between a compound having a carboxylic acid group and a compound having an amino group, for example. A urethane group is obtained by a condensation reaction between a compound having an isocyanate group and a compound having a hydroxyl group, for example.

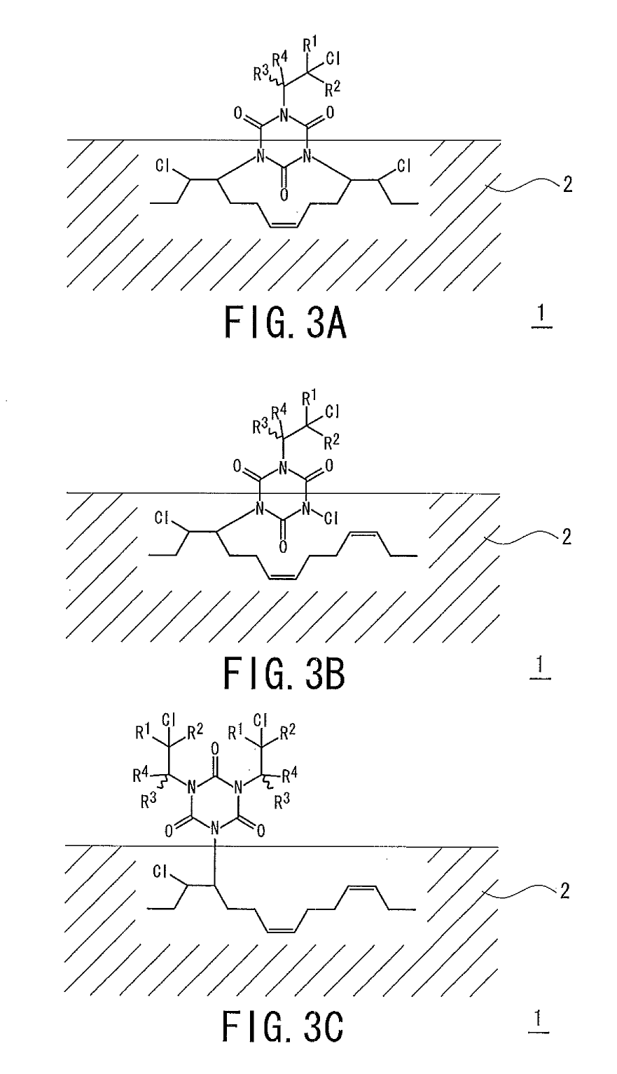

FIGS. 3A to 3C are schematic views showing examples of the state of the surface of the modified polymer substrate of the present invention. In any of FIGS. 3A to 3C, the modified polymer substrate 1 has a configuration such that the organic group(s) having the specific functional group(s) R1 is (are) bonded to the surface of the polymer substrate 2 via the isocyanuric acid backbone.

In the configuration shown in FIG. 3A, the isocyanuric acid backbone is bonded to the polymer substrate 2 by two N atoms, and one organic group is bonded to one isocyanuric acid backbone. In the configuration shown in FIG. 3B, the isocyanuric acid backbone is bonded to the polymer substrate 2 by one N atom, and one organic group is bonded to one isocyanuric acid backbone. In the configuration shown in FIG. 3C, the isocyanuric acid backbone is bonded to the polymer substrate 2 by one N atom, and two organic groups are bonded to one isocyanuric acid backbone. The two organic groups in FIG. 3C may have functional groups different from each other or may have same functional groups.

In addition, chlorine atoms are bonded to the surface of the polymer substrate 2. In the modified polymer substrate 1 of the present invention, chlorine atoms exist not only on the surface the modified polymer substrate 1 but also inside thereof, where the abundance of chlorine atoms increases gradually from the inside to the surface.

The modified polymer substrate of the present invention may have some of the structures shown in FIGS. 3A to 3C, or may have all the structures shown in FIGS. 3A to 3C.

The features of the modified polymer substrate 1 of the present invention that the isocyanuric acid backbones are bonded to the polymer substrate 2, that the organic groups having the specific functional groups are bonded to the surface of the polymer substrate 2 via the isocyanuric acid backbones, that the chlorine atoms are bonded to the surface of the polymer substrate 2, and that the abundance of chlorine atoms increases gradually from the inside to the surface can be detected also by XPS or NMR while the features can be sufficiently imagined because surface treatment is performed on the surface with the use of a surface treatment agent in a method for producing the modified polymer substrate to be described later.

To be specific, in XPS, the amounts of chlorine atoms, silicone atoms and fluorine atoms on the surface of the modified polymer substrate 1 can be analyzed. Analyzing the amounts of silicone atoms and fluorine atoms can make it possible to analyze the amount of the specific functional groups. In addition, in NMR, the material of the surface of the modified polymer substrate 1 is scraped off the surface, for example, which is chemically dissolved if necessary, and thus can be analyzed by ¹³C-NMR or ¹H-NMR. Analyzing in this manner can make it possible to find the presence or absence of isocyanuric acid backbones, the bonded positions of isocyanuric acid backbones and the amount of isocyanuric acid backbones, and the presence or absence of silicone atoms and fluorine atoms, the bonded positions of silicone atoms and fluorine atoms and the amount of silicone atoms and fluorine atoms. Thus, the configuration of the surface of the modified polymer substrate 1 can be detected based on the obtained results.

Because the modified polymer substrate 1 of the present invention has the configuration that the organic groups having the specific functional groups R1 arranged to provide functions to the surface of the polymer substrate 2 are bonded to the surface of the polymer substrate 2 via the isocyanuric acid backbones, the modified polymer substrate 1 can be provided with both excellent releasability from an accretion adhering to the surface of the polymer substrate 1 and functions for intended use other than releasability. In addition, being covalently-bonded to the surface of the polymer substrate 2, the functional groups R¹ arranged to provide functions to the surface of the polymer substrate 2 and the isocyanuric acid backbones are not detached easily from the surface of the polymer substrate 2. Thus, those provided functions are excellent in durability.

Next, a description of a surface treatment agent of the present invention that is favorably used to obtain the modified polymer substrate of the present invention will be provided.

The surface treatment agent of the present invention contains a component (a) that define a trichloroisocyanuric acid, and a component (b) that defines a compound that has unsaturated carbon-to-carbon double bonds and organic groups having functional groups arranged to provide functions to the surface of the polymer substrate. The trichloroisocyanuric acid of the component (a) is expressed in a structural formula (A) of chemical formula 14. The component (b) is expressed in a structural formula (B) of chemical formula 14. In the structural formula (B), R¹ indicates a substituent that has the specific functional group. In the surface treatment agent of the present invention, 1,2-addition of the component (a) to the unsaturated carbon-to-carbon double bond occurs to form a new compound expressed in a structural formula (C) as shown in chemical formula 14. This addition reaction occurs sufficiently at room temperature.

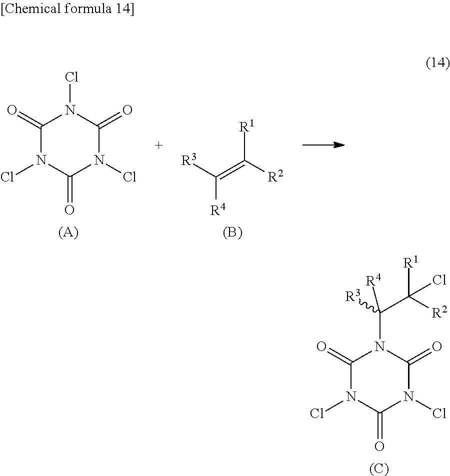

In addition, the compound expressed in the structural formula (C) has an N—Cl bond of which an addition reaction with the unsaturated carbon-to-carbon double bond occurs. Thus, it is assumed that 1,2-addition of the compound expressed in the structural formula (C) to another unsaturated carbon-to-carbon double bond of the component (b) occurs to form a new compound expressed in chemical formula 15 in the surface treatment agent of the present invention. That is, it is assumed that the compound expressed in the structural formula (C) and the compound expressed in chemical formula 15 exist at a given ratio in the surface treatment agent of the present invention.

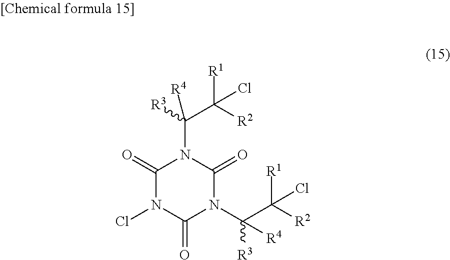

The specific functional group is arranged to provide specific functions to the surface of the polymer substrate. Examples of the functional group include a silicone group, a fluorine-containing group, a perfluoroalkyl group, an ester group, an amide group, an imide group, an ether group, an aryl group, an azo group, a diazo group, a nitro group, an epoxy group, a carbonyl group, a heterocyclic group, a mesoionic group, a halogen group, an amino group, an imino group, an alkyl group, a sulfonic acid group, a hydroxyl group, an acyl group, a formyl group, a carboxylic acid group, a urea group, a urethane group, and a cyano group. The organic group may have one kind of functional group, or two or more than two kinds of functional groups, which are selected from the functional groups described above.

It is also preferable that R², R³ and R⁴ are substituents same as R¹, substituents having specific functional groups other than R¹, or hydrogen groups or alkyl groups. It is also preferable that R¹, R², R³ and R⁴ are substituents having specific functional groups different from one another, or some of them are substituents of a same kind. R², R³ and R⁴ are preferably hydrogen groups in view of stability.

Preferable examples of the component (b) are expressed in chemical formulas 16 to 19. Chemical formulas 16 and 17 are examples that the organic groups have silicone groups and ester groups. Chemical formula 18 is an example that the organic group has an alkyl group and an ester group. Chemical formula 19 is an example that the organic group has an alkyl group.

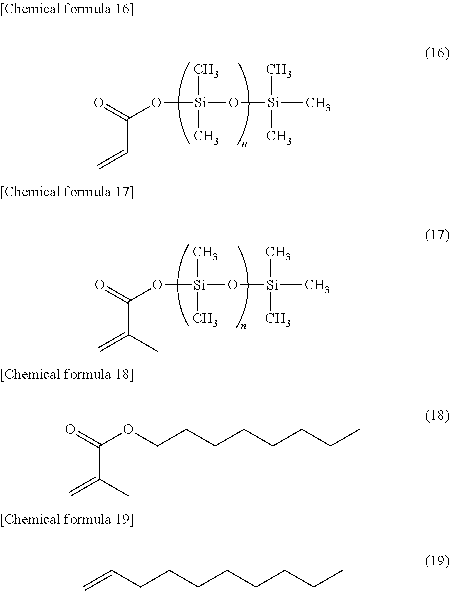

The surface treatment agent of the present invention may contain one kind or more than one kind of the component (b).

The molecular weight of the component (b) is preferably within the range of 50 to 10000, and more preferably within the range of 70 to 5000. This is because volatilization of the component (b) is liable to increase if the molecular weight is lower than 50, so that tractability of the component (b) decreases. On the other hand, reactivity of the component (b) to the component (a) is liable to abate if the molecular weight is higher than 10000, so that it is difficult to provide desired functions to the polymer substrate.

The component (a) and the component (b) are mixed preferably at a molar ratio within the range of a/b=1/2 to 1/0.01, where “a” represents the content of the component (a) and “b” represents the content of the component (b). If the content of the component (b) is too small and goes out of the above-described range, an effect of providing the specific functions obtained based on the specific functional groups of the component (b) is liable to be lessened. On the other hand, if the content of the component (a) is too small and goes out of the above-described range, reactivity of the component (a) to the polymer substrate is liable to abate, so that it is difficult to sufficiently provide the desired functions to the polymer substrate. Alternatively, the provided functions cannot obtain durability.

It is preferable that the surface treatment agent of the present invention contains a solvent in which the component (a) and the component (b) are dissolved or dispersed. The kind of the solvent is not limited specifically. Examples of the solvent include an ethers solvent (e.g., THF, diethyl ether, dioxane), an esters solvent (e.g., ethyl acetate, butyl acetate), a ketones solvent (e.g., acetone, MEK), an amides solvent (e.g., DMF, DMAC, NMP), tertiary alcohol (e.g., tert-butyl alcohol), and water. They may be used singly or in combination. For example, it is also preferable to use two kinds of solvents consisting of a solvent for dissolving or dispersing the component (a) and a solvent for dissolving or dispersing the component (b).

The concentration of the component (a) in the solvent is preferably within the range of 1 to 10 parts by mass with respect to 100 parts by mass of solvent, and more preferably within the range of 2 to 5 parts by mass. If the concentration of the component (a) is too low and goes out of the above-described range, reactivity of the component (a) to the polymer substrate is liable to abate, so that it is difficult to sufficiently provide the desired functions to the polymer substrate. On the other hand, if the concentration of the component (a) is too high and goes out of the above-described range, nonuniformity in the treatment performed on the polymer substrate is liable to become large.

The surface treatment agent of the present invention may contain another component in addition to the component (a) and the component (b). Examples of the another component include a catalyst such as acid, a base and a metallic salt, and a surface-active agent.

The surface treatment agent of the present invention having the configuration described above contains the compound expressed in the structural formula (C) or the compound expressed in chemical formula 15. The surface treatment agent is brought into contact with the surface of the polymer substrate containing the organic component having unsaturated carbon-to-carbon double bonds, whereby 1,2-addition of the compound expressed in the structural formula (C) or the compound expressed in chemical formula 15 to the unsaturated carbon-to-carbon double bonds in the polymer substrate occurs at N—Cl bond sections of the trichloroisocyanuric acid. Thus, the modified polymer substrate of the present invention that the organic groups having the specific functional groups are bonded to the surface of the polymer substrate via the isocyanuric acid backbones is obtained.

Next, a description of a method for producing a modified polymer substrate of the present invention (hereinafter, referred to also as the present production method) will be provided.

The present method includes a step of bringing a specific treatment solvent into contact with a surface of a specific polymer substrate. The surface treatment agent of the present invention can be used as the specific treatment solvent.

The specific polymer substrate defines a polymer substrate that contains an organic component having unsaturated carbon-to-carbon double bonds. The organic component may be a polymer component of the polymer substrate, or may be a low-molecular weight component or an oligomer component contained in the polymer component. That is, the polymer component itself may have unsaturated carbon-to-carbon double bonds, or the low-molecular weight component or the oligomer component contained in the polymer component may have unsaturated carbon-to-carbon double bonds. The polymer component may be any one of rubber, a resin and an elastomer.

Examples of the polymer component having the unsaturated carbon-to-carbon double bonds include natural rubber (NR), isoprene rubber (IR), butadiene rubber (BR), acrylonitrile-butadiene rubber (NBR), styrene-butadiene rubber (SBR) chloroprene rubber (CR), butyl rubber (IIR) and ethylene-propylene diene rubber (EPDM).

In addition, even a polymer component that originally have no unsaturated carbon-to-carbon double bonds can be made into a polymer component into which unsaturated carbon-to-carbon double bonds are introduced by copolymerizing a monomer component having unsaturated carbon-to-carbon double bonds onto the polymer component that originally have no unsaturated carbon-to-carbon double bonds. Examples of the polymer component that originally have no unsaturated carbon-to-carbon double bonds include acrylic rubber (ACM), fluororubber (FKM), chlorosulfonated polyethylene (CSM), hydrinrubber (e.g., CO, ECO), silicone rubber (Q), urethane (U), an ethylene-vinyl acetate copolymer (EVA), a polyethylene resin, an epoxy resin, and polyamide.

Examples of the monomer component having unsaturated carbon-to-carbon double bonds include liquid rubber and butadienediol.

If urethane is used, unsaturated carbon-to-carbon double bonds can be introduced into the urethane by adding liquid butadienediol to a two-package urethane coating.

If the low-molecular weight component or the oligomer component having the unsaturated carbon-to-carbon double bonds is used, the component needs to be prevented from bleeding from the polymer substrate because the component is only contained in the polymer component. In order to fulfill this need, it is preferable that a material that has an SP value (a solubility parameter) close to that of the polymer component is selected for the low-molecular weight component or the oligomer component, or that the molecular weight of the low-molecular weight component or the oligomer component is raised as much as possible (for example, a low-molecular weight component or an oligomer component having unsaturated carbon-to-carbon double bonds having a molecular weight of 2000 or more is used).

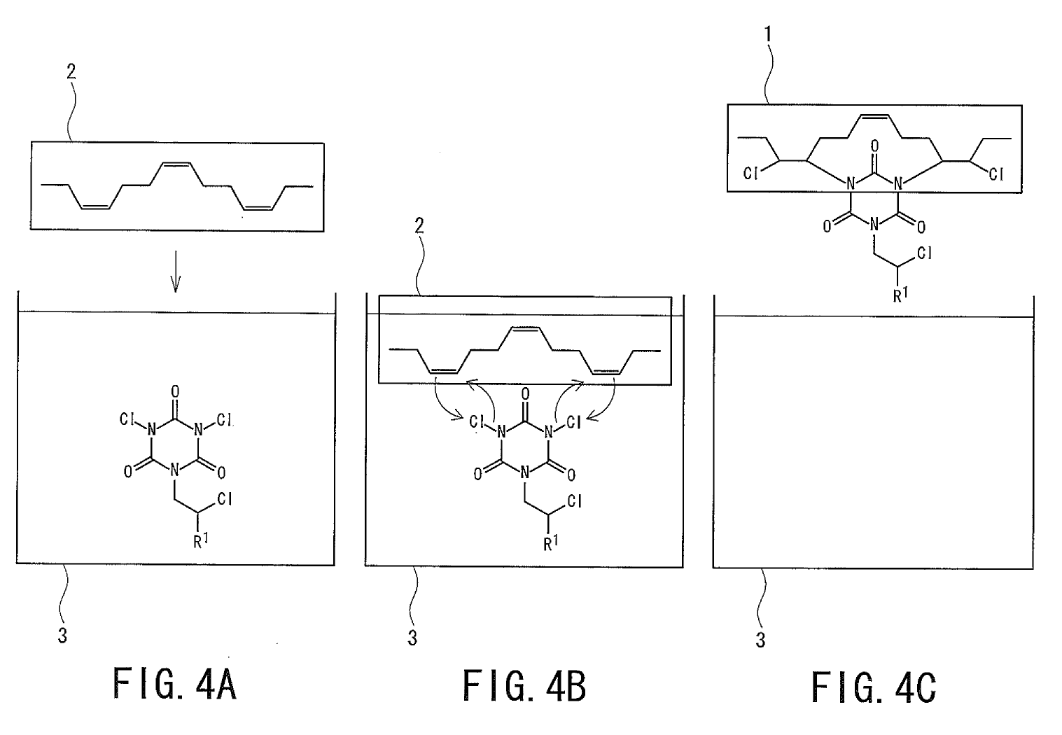

Examples of the method for bringing the specific treatment solvent into contact with the surface of the specific polymer substrate include a method for directly soaking the polymer substrate 2 in a treatment solvent 3 as shown in FIGS. 4A to 4C. The compound expressed in the structural formula (C) is shown as an example of a substance in the treatment solvent in FIGS. 4A to 4C; however, the compound expressed in the structural formula (C) is only an example of the compounds existing as the substrates in the treatment solvent. The present invention is not limited to the compound expressed in the structural formula (C), and the compound expressed in chemical formula 15 may be contained as the substrate in the treatment solvent.

It is essential only that the temperature of the treatment solvent 3 should be a room temperature; however, it is preferable that the temperature is within the range of 20 to 100 degrees C., and it is more preferable that the temperature is within the range of 25 to 70 degrees C. If the temperature of the treatment solvent 3 is less than 20 degrees C., reactivity of the substrate in the treatment solvent (e.g., the compound expressed in the structural formula (C)) to the unsaturated carbon-to-carbon double bonds existing on the surface of the polymer substrate 2 is liable to abate. On the other hand, if the temperature of the treatment solvent 3 is more than 100 degrees C., the treatment performed on the polymer substrate 2 is liable to become nonuniform.

The soaking does not require a long time. For example, it is essential only that the soaking should be performed for about ten seconds to one hour. If the soaking is performed for less than ten seconds, the contact time is too short to obtain a sufficient surface-treatment effect. On the other hand, even if the soaking is performed for more than one hour, the surface-treatment effect cannot be increased, which decreases the productivity.

After soaking the polymer substrate 2 in the treatment solvent 3, the polymer substrate 2 is picked up from the treatment solvent 3 as shown in FIG. 4C. It is preferable that the polymer substrate 2 is then cleaned and dried.

It is essential only that a cleaning solvent should be easily mixed with the solvent in the treatment solvent 3 and be capable of washing away unreacted substrates. The cleaning solvent is not limited specifically. For example, a solvent same as one or more than one kind of solvent in the treatment solvent 3 can be used.

The cleaning does not require a long time. For example, it is essential only that the cleaning should be performed for about ten seconds to ten minutes. If the cleaning is performed for less than ten seconds, the cleaning time is too short to obtain a sufficient cleaning effect. Thus, unreacted substrates are liable to be left on the surface of the polymer substrate 2. On the other hand, even if the cleaning is performed for more than ten minutes, the cleaning effect cannot be increased, which decreases the productivity.

It is essential only that the drying temperature should be a room temperature; however, it is preferable that the temperature is within the range of the room temperature to 250 degrees C., and it is more preferable that the temperature is within the range of the room temperature to 100 degrees C. If the drying temperature is less than the room temperature, the solvent does not volatilize easily, and the drying requires a long time. On the other hand, if the drying temperature is more than 250 degrees C., the polymer substrate 2 is liable to deteriorate, and the energy required for the drying becomes too large.

Because the present production method can provide both excellent releasability from an accretion adhering to the surface of the polymer substrate 2 and functions for intended use other than releasability to the surface of the polymer substrate 2 containing the organic component having unsaturated carbon-to-carbon double bonds, a modified polymer substrate 1 that has releasability from an accretion adhering to the surface of the polymer substrate 2 and functions for intended use other than releasability can be provided by the method.

The present production method can be used for producing polymer substrates of various polymer products. In particular, the present production method can be preferably used for producing polymer substrates of polymer products surfaces of which are required to have a plurality of functions, not a single function. For example, the present production method can be preferably used for producing polymer substrates from which surfaces of conductive members for electrophotographic machine or automobile wipers are made. In addition, the present production method can be preferably used for producing a printing roller, a papermaking roller, a conveying roller and a laminating roller. Examples of the conductive members for electrophotographic machine include a conductive roller (e.g., a development roller, a charging roller, a transfer roller, a toner supply roller), a conductive belt (e.g., a transfer belt), and a conductive blade (e.g. a cleaning blade).

The conductive roller is produced as follows, for example. First, an axis member is coaxially set in a hollow portion of a molding die for roller. Then, the die is filled with a conductive composition. Then, the conductive composition is heated and cured, and released from the die. Thus, a single-layered conductive roller is produced, which has a configuration such that an elastic layer (base layer) of a single layer is formed around the axis member.

In addition, the axis member having the elastic layer (base layer) of the single layer formed therearound is coaxially set in a hollow portion of a molding die for roller. Then, the die is filled with a conductive composition. Then, the conductive composition is heated and cured, and released from the die. Thus, a double-layered conductive roller is produced, which has a configuration such that the elastic layers of double layers are formed around the axis member.

In addition, the conductive belt is produced as follows, for example. First, a conductive composition is spray coated on a surface of a cylindrical die. Then, the conductive composition is heated and cured. Thus, a base layer of the conductive belt is formed. Then, a conductive composition is spray coated on a surface of the base layer. Then, the conductive composition is heated and cured. Thus, an elastic layer is formed on a surface of the base layer of the conductive belt. Then, air is blown between the base layer and the cylindrical die to remove the base layer from the die. Thus, the conductive belt is produced.

The elastic layer of the single-layered conductive roller, the outer elastic layer of the double-layered conductive roller, the outer elastic layer of the conductive belt define layers that are located on surfaces of the conductive rollers or a surface of the conductive belt. It is preferable that the conductive compositions contained in the layers located on the surfaces of the members contain the specific polymer component, i.e., the polymer component having unsaturated carbon-to-carbon double bonds, or the polymer component into which unsaturated carbon-to-carbon double bonds are introduced by copolymerizing the monomer component having unsaturated carbon-to-carbon double bonds.

It is preferable that the conductive compositions contain not only the specific polymer component but also a conductive agent (an electronic conductive agent such as carbon black, a quaternary ammonium salt, a quaternary phosphonium salt, a borate salt, and an ion conductive agent such as a surface-active agent), another polymer component, and additives of various kinds as necessary. Examples of the additives include a weighting agent, a strengthening agent, a processing aid, a curing agent, across-linking agent, a cross-linking promoter, a blowing agent, an antioxidant, a plasticizer, an ultraviolet absorber, a silicone oil, a lubricant, an auxiliary agent, and a surface-active agent.

The conductive compositions of the base layers of the double-layered conductive roller and the conductive belt may contain the specific polymer components or may not contain the specific polymer components. Examples of the polymer components contained in the conductive compositions of the base layers include natural rubber (NR), isoprene rubber (IR), butadiene rubber (BR), acrylonitrile-butadiene rubber (NBR), styrene-butadiene rubber (SBR) chloroprene rubber (CR), butyl rubber (IIR), ethylene-propylene diene rubber (EPDM), acrylic rubber (ACM), fluororubber (FKM), chlorosulfonated polyethylene (CSM), hydrinrubber (e.g., CO, ECO), silicone rubber (Q), urethane (U), an ethylene-vinyl acetate copolymer (EVA), a polyethylene resin, an epoxy resin, and polyamide. It is preferable that the conductive compositions of the base layers further contain a conductive agent, and additives of various kinds.

The axis member is not limited specifically as long as having conductivity. Examples of the axis member include a solid member and a cored bar of hollow body that are made from metal such as iron, stainless and aluminum. It is preferable to coat the surface of the axis member with an adhesive or a primer as necessary. It is preferable to provide the adhesive or the primer with electrical conductivity as necessary.

It is preferable that the modified polymer substrate of the present invention includes the polymer substrate, a surface of which has asperities. If used for an outermost layer of a development roller, the modified polymer substrate including the polymer substrate the surface of which has asperities can further enhance the ability of the development roller to convey toner, and also can further minimize toner filming.

The asperities may be provided by (1) particles for forming surface roughness that are contained inside of the polymer substrate, or may be provided by (2) die-forming the polymer substrate, using a molding die that has a plurality of concave portions corresponding to the asperities on an inner surface of the molding die that is in contact with the surface of the polymer substrate. In the case of (2) die-forming, the concave portions on the inner surface of the molding die may be formed by (2-1) blast finishing the inner surface of the molding die, or may be formed by (2-2) defects in plating that are formed during the process of plating given onto the inner surface of the molding die, or may be formed by (2-3) removing resin particles contained in a plated layer that is formed on the inner surface of the molding die.

In (1), examples of the particles for forming surface roughness include acrylic particles, silica particles, urethane particles, cross-linked polymethylmethacrylate particles, and urea resin particles. It is preferable that the particles for forming surface roughness of one or more than one kind are used. The average particle diameter of the particles for forming surface roughness is not limited specifically; however, it is preferably within the range of 6 to 20 μm in view of capable of forming appropriate asperities that allow excellent toner-conveying volume in relation with the particle size of the toner. The average particle diameter of the particles for forming surface roughness can be measured preferably using a particle size measurement device, “MICROTRACK UPA-ST150” (manufactured by NIKKISO CO., LTD.).

In (2-2), the defects in plating result from intentionally-made defective electroless plating. That is, hydrogen gas that generates during the plating reaction is absorbed in a surface of the deposited plating, whereby further deposition of the plating is inhibited at the portions where the hydrogen gas is absorbed, and thus the defects in plating are formed. It is preferable that a plating bath contains a hydrocarbon cationic surfactant such as lauryl trimethylammonium chloride, and an ampholytic surfactant such as lauryl betaine considering that these surfactants allow the hydrogen gas that generates during the plating reaction to be easily absorbed in the surface to form the defects in plating more easily. Examples of the metal for plating include nickel, cobalt, copper, tin, palladium and gold. These metals, a reducing agent that is used in a plating bath for normal composite electroless plating, and a complexing agent are mixed appropriately in the plating bath.

In (2-3), the plated layer is formed by electroless plating using a plating liquid containing the resin particles. The resin particles are removed from the plated layer by dissolving using a solvent, whereby concave portions are formed in the plated layer at the portions where the resin particles used to be. Resin particles that can be dissolved in the solvent are used as the present resin particles. Examples of the resin particles include acrylic particles, styrene particles, urethane particles, nylon particles, silicone particles and cellulose particles. The plating liquid contains metal ions, a reducing agent, a complexing agent, a ph buffering agent, the above-described resin particles and other ingredients. The metal ions define ions of plating metal. Examples of the plating metal include nickel, cobalt, copper, gold and silver. Examples of the complexing agent include a carboxylic acid and an amine compound. If the carboxylic acid and the amine compound are used together, the resin particles and the plating metal can be made eutectoid at high densities. If the amine compound is used, column crystals of the plating metal grow. Thus, the depths of the concave portions can be made larger than the particle diameter of the resin particles.

### EXAMPLE

A description of the present invention will now be specifically provided with reference to examples. It is to be noted that the examples define conductive members for electrophotographic machine, for example; however, the present invention is not limited to this definition.

(Preparation of Subject A1 of Treatment)

A solid columnar iron bar 12 mm in diameter was prepared as a solid member that defined an axis member, and an adhesive was applied on an outer surface of the solid member. The solid member coated with the adhesive was set in a molding die. Then, liquid silicone rubber containing a conductive agent (Manuf.: SHIN-ETSU CHEMICAL CO., LTD., X-34-264A/B, mixing ratio: A/B=70/30) was injected into the die, heated and cured at 190 degrees C. for 30 minutes, and then released from the die. Thus, a single-layered conductive roller was produced, which included the solid member, and a rubber elastic layer (2 mm in thickness) of single layer that surrounded the outer surface of the solid member and contained silicone rubber having C—C bonds left on its surface. This roller was defined as a subject A1 of treatment.

(Preparation of Subject A2 of Treatment)

A material compound was prepared by kneading 100 parts by mass of NBR (manuf.: JSR, N222L), 5 parts by mass of zinc oxide, 2 parts by mass of stearic acid, 1 part by mass of tetrabutylammonium perchlorate (reagent), 0.8 parts by mass of powder sulfur, and 10 parts by mass of polyester plasticizer (manuf.: DIC, POLYCIZER-W-4000) for 10 minutes in a sealed mixer that was adjusted to 50 degrees C. By using the material compound as a material for rubber elastic layer, a single-layered conductive roller was produced, which included a solid member, and a rubber elastic layer (2 mm in thickness) of single layer that surrounded the outer surface of the solid member and contained the NBR, in a same manner as the subject A1 except that the material compound was used for the material for rubber elastic member. This roller was defined as a subject A2 of treatment.

(Preparation of Subject A3 of Treatment)

A single-layered conductive roller was produced in a same manner as the subject A2 except that a die to be described below was used as a die into which a material for rubber elastic layer was injected. This roller was defined as a subject A3 of treatment.

<Preparation of Molding Die to which Surface Roughness is Provided>

Electroless plating was performed on an inner surface of a cylindrical base die 16 mm in inner diameter using a plating liquid to be described below under the conditions that the plating liquid was pH 8 and was adjusted to 80 degrees C., and a plating time was 120 minutes, whereby an electroless plating layer containing acrylic particles was formed (16 μm in plating thickness). Then, the acrylic particles in the electroless plating layer was removed by dissolving them using acetone, whereby a molding die that had a plurality of concave portions on its inner surface was prepared.

[Preparation of Plating Liquid]

A resin-particle dispersed liquid that was prepared by dispersing acrylic particles <1> (manuf.: NEGAMI CHEMICAL INDUSTRIAL CO., LTD, ART PEARL GR600, average particle diameter: 10 μm) in water using a cationic surfactant such as lauryl trimethyl ammonium chloride was added to a base plating liquid, whereby a plating liquid having composition to be described below was prepared.

[Composition of Plating Liquid]

Nickel sulfate hexahydrate: 26 g/L

Sodium hypophosphite monohydrate (reducing agent): 32 g/L

Glycine (complexing agent): 7.5 g/L

Sodium citrate dihydrate (complexing agent): 30 g/L

Acrylic particles <1>: 20 g/L

Cationic surfactant: 0.1 g/L

(Preparation of Subject A4 of Treatment)

By using liquid silicone rubber containing a conductive agent (Manuf.: SHIN-ETSU CHEMICAL CO., LTD., X-34-264A/B, mixing ratio: A/B=50/50) as a material for rubber elastic layer, a rubber elastic layer (2 mm in thickness) containing the silicone rubber was produced around a solid member in a same manner as the subject A1 except that the liquid silicone rubber was used for the material for rubber elastic member. Next, a composition (1) for forming a resin layer to be described below was coated on an outer surface of the rubber elastic layer by a roll coating method, and then drying treatment (180 degrees C.×60 minutes) was performed thereon, whereby a resin layer 10 μm in thickness was formed around an outer surface of the base roller. Thus, a double-layered conductive roller was produced. The roller was defined as a subject A4 of treatment.

### <Preparation of Composition (1) for Forming Resin Layer>

90 parts by mass of urethane resin that defined a binder resin (manuf.: NIPPON POLYURETHANE INDUSTRY CO., LTD., “NIPPOLAN 5199”), 10 parts by mass of polyol that contains C═C bonds (manuf: IDEMITSU KOSAN CO., LTD., “Poly bdR-45HT”), 40 parts by mass of isocyanate MDI that defined a cross-linking agent (manuf.: NIPPON POLYURETHANE INDUSTRY CO., LTD., “CORONATE L”), and 30 parts by mass of carbon black that defined a conductive agent (manuf: MITSUBISHI CHEMICAL CORPORATION, “DIABLACK #3030” were sufficiently mixed and dissolved in an organic solvent (methyl ethyl ketone), whereby a coating liquid that had a concentration of 20% by mass was prepared.

(Preparation of Subject B1 of Treatment)

A double-layered conductive roller was produced in a same manner as the subject A1 except that a composition (2) for forming a resin layer to be described below was used instead of the composition (1). This roller was defined as a subject B1 of treatment.

### <Preparation of Composition (2) for Forming Resin Layer>

100 parts by mass of urethane resin that defined a binder resin (manuf.: NIPPON POLYURETHANE INDUSTRY CO., LTD., “NIPPOLAN 5199”), 40 parts by mass of isocyanate MDI that defined a cross-linking agent (manuf.: NIPPON POLYURETHANE INDUSTRY CO., LTD., “CORONATE L”), and 30 parts by mass of carbon black that defined a conductive agent (manuf.: MITSUBISHI CHEMICAL CORPORATION, “DIABLACK #3030”) were sufficiently mixed and dissolved in an organic solvent (methyl ethyl ketone), whereby a coating liquid that had a concentration of 20% by mass was prepared. The composition (2) was different from the composition (1) in that the composition (2) contained no polyol containing C═C bonds.

(Preparation of Subject A5 of Treatment)

A double-layered conductive roller was produced in a same manner as the subject A1 except that a composition (3) for forming a resin layer to be described below was used instead of the composition (1). This roller was defined as a subject A5 of treatment.

### <Preparation of Composition (3) for Forming Resin Layer>

90 parts by mass of urethane resin that defined a binder resin (manuf.: NIPPON POLYURETHANE INDUSTRY CO., LTD., “NIPPOLAN 5199”), 10 parts by mass of polyol that contains C═C bonds (manuf.: IDEMITSU KOSAN CO., LTD., “Poly bdR-45HT”), 40 parts by mass of isocyanate MDI that defined a cross-linking agent (manuf.: NIPPON POLYURETHANE INDUSTRY CO., LTD., “CORONATE L”), 30 parts by mass of carbon black that defined a conductive agent (manuf: MITSUBISHI CHEMICAL CORPORATION, “DIABLACK #3030”), and 1 part by mass of a silicone oil that contains C═C bonds (manuf: SHIN-ETSU CHEMICAL CO., LTD., X-22-174DX) were sufficiently mixed and dissolved in an organic solvent (methyl ethyl ketone), whereby a coating liquid that had a concentration of 20% by mass was prepared. The composition (3) was different from the composition (1) in that the composition (3) further contained the silicone oil containing C═C bonds.

(Preparation of Subject A6 of Treatment)

A double-layered conductive roller was produced in a same manner as the subject A1 except that a composition (4) for forming a resin layer to be described below was used instead of the composition (1). This roller was defined as a subject A6 of treatment.

### <Preparation of Composition (4) for Forming Resin Layer>

90 parts by mass of urethane resin that defined a binder resin (manuf: NIPPON POLYURETHANE INDUSTRY CO., LTD., “NIPPOLAN 5199”), 10 parts by mass of polyol that contains C═C bonds (manuf: IDEMITSU KOSAN CO., LTD., “Poly bdR-45HT”), 40 parts by mass of isocyanate MDI that defined a cross-linking agent (manuf: NIPPON POLYURETHANE INDUSTRY CO., LTD., “CORONATE L”), 30 parts by mass of carbon black that defined a conductive agent (manuf.: MITSUBISHI CHEMICAL CORPORATION, “DIABLACK #3030”), and 15 parts by mass of urethane particles that defined particles for forming surface roughness (manuf.: NEGAMI CHEMICAL INDUSTRIAL CO., LTD, ART PEARL C800 transparent) were sufficiently mixed and dissolved in an organic solvent (methyl ethyl ketone), whereby a coating liquid that had a concentration of 20% by mass was prepared.

(Preparation of Subject A7 of Treatment)

100 parts by mass of polyamide-imide resin (manuf.: TOYOBO CO., LTD., “HR-16NN”), 10 parts by mass of carbon black (manuf.: DENKI KAGAKU KOGYO KABUSHIKI KAISHA, “DENKA BLACK HS-100”), and 800 parts by mass of NMP (solvent) were mixed, whereby a solvent in which a polyamide-imide resin was dispersed was prepared. Then, thus-prepared solvent was spray coated on a surface of a cylindrical die, and heat-treated by raising the temperature from room temperature to 250 degrees C. spending 2 hours and keeping the temperature at 250 degrees C. for 1 hour. Thus, a base layer (80 μm in thickness) of a conductive belt was formed.

Then, a composition (1) for forming an elastic layer to be described below was spray coated on a surface of the base layer, and heat-treated by raising the temperature from room temperature to 170 degrees C. spending 5 minutes and keeping the temperature at 170 degrees C. for 30 minutes. Thus, an elastic layer (170 μm in thickness) was formed on the surface of the base layer. Then, air was blown between the base layer and the cylindrical die to remove the base layer from the die. Thus, the conductive belt was produced. This belt was defined as a subject A7 of treatment.

### <Preparation of Composition (1) for Forming Elastic Layer>

Liquid NBR(NH² modified NBR, manuf.: EMERALD PERFORMANCE MATERIALS, “ATBN 1300×45”), 35 parts by mass of blocked isocyanate that defined a cross-linking agent (manuf.: NIPPON POLYURETHANE INDUSTRY CO., LTD., “CORONATE 2507”), and cyclohexane that defined a solvent (30% by mass) were mixed, whereby a composition (1) for forming an elastic layer was prepared.

(Preparation of Subject A8 of Treatment)

A conductive belt was produced in a same manner as the subject A7 except that a composition (2) for forming an elastic layer to be described below was used instead of the composition (1). This belt was defined as a subject A8 of treatment.

### <Preparation of Composition (2) for Forming Elastic Layer>

100 pats by mass of liquid NBR (NH² modified NBR, manuf.: EMERALD PERFORMANCE MATERIALS, “ATBN 1300×45”), 1 part by mass of a silicone oil that contains C═C bonds (manuf: SHIN-ETSU CHEMICAL CO., LTD., X-22-174DX), 35 parts by mass of blocked isocyanate that defined a cross-linking agent (manuf.: NIPPON POLYURETHANE INDUSTRY CO., LTD., “CORONATE 2507”), and cyclohexane that defined a solvent (30% by mass) were mixed, whereby the composition (2) for forming the elastic layer was prepared. The composition (2) was different from the composition (1) in that the composition (2) further contains the silicone oil containing C═C bonds.

### <Preparation of Surface Treatment Agent A1>

5 parts by mass of trichloroisocyanuric acid (manuf.: TOKYO CHEMICAL INDUSTRY CO., LTD.), 1 part by mass of a silicone oil that contains C═C bonds (manuf.: SHIN-ETSU CHEMICAL CO., LTD., X-22-174DX), 80 parts by mass of tert-butyl alcohol, and 20 parts by mass of ethyl acetate were mixed, whereby a surface treatment agent A1 was prepared.

### <Preparation of Surface Treatment Agent A2>

2.5 parts by mass of trichloroisocyanuric acid (manuf.: TOKYO CHEMICAL INDUSTRY CO., LTD.), 0.2 parts by mass of a silicone oil that contains C═C bonds (manuf.: SHIN-ETSU CHEMICAL CO., LTD., X-22-174DX), 2 parts by mass of butyl acrylate, 80 parts by mass of tert-butyl alcohol, and 20 parts by mass of ethyl acetate were mixed, whereby a surface treatment agent A2 was prepared.

### <Preparation of Surface Treatment Agent A3>

5 parts by mass of trichloroisocyanuric acid (manuf.: TOKYO CHEMICAL INDUSTRY CO., LTD.), 0.5 parts by mass of perfluorhexyl ethylene, 80 parts by mass of tert-butyl alcohol, and 20 parts by mass of ethyl acetate were mixed, whereby a surface treatment agent A3 was prepared.

### <Preparation Of Surface Treatment Agent B1>

5 parts by mass of trichloroisocyanuric acid (manuf.: TOKYO CHEMICAL INDUSTRY CO., LTD.), 80 parts by mass of tert-butyl alcohol, and 20 parts by mass of ethyl acetate were mixed, whereby a surface treatment agent B1 was prepared.

### <Preparation of Surface Treatment Agent B2>

A silicone oil that contains C═C bonds (manuf.: SHIN-ETSU CHEMICAL CO., LTD., X-22-174DX) was defined as a surface treatment agent B2.

### <Preparation of Surface Treatment Agent B3>

5 parts by mass of diphenylmethane diisocyanate, 2 parts by mass of acrylic silicone resin that contains OH groups (manuf.: NOF CORPORATION, “MODIPER FS700”), and 100 parts by mass of ethyl acetate were mixed, whereby a surface treatment agent B3 was prepared.

### <Preparation of Surface Treatment Agent B4>

2 parts by mass of trichloroisocyanuric acid (manuf.: TOKYO CHEMICAL INDUSTRY CO., LTD.), 2 parts by mass of boron tri fluor ide-diethyl ether complex (manuf.: KANTO CHEMICAL CO., INC., containing 48% by mass of BF³), 80 parts by mass of tert-butyl alcohol, and 20 parts by mass of ethyl acetate were mixed, whereby a surface treatment agent B4 was prepared.

### Example 1

The subject A1 of treatment was soaked in the surface treatment agent A1 at 25 degrees C. for 30 seconds such that the surface of the roller was soaked. Then, the roller surface was washed with ethyl acetate at 25 degrees C. for 30 seconds, and dried at 100 degrees C. for 10 minutes. Thus, a single-layered conductive roller of Example 1 was obtained.

### Comparative Example 1

The subject A1 of treatment, which was not subjected to surface treatment using a surface treatment agent, was defined as a single-layered conductive roller of Comparative example 1.

### Comparative Examples 2 to 3

The subjects A1 of treatment were subjected to surface treatment in a same manner as Example 1 except that the surface treatment agents B1 to B2 were used instead of the surface treatment agent A1. Thus, single-layered conductive rollers of Comparative examples 2 to 3 were obtained.

### Comparative Example 4

The subject A1 of treatment was soaked in the surface treatment agent B3 at 25 degrees C. for 30 seconds such that the surface of the roller was soaked. Then, the roller surface was heated at 120 degrees C. for 60 minutes. Thus, a single-layered conductive roller of Comparative example 4 was obtained.

### Example 2

The subject A2 of treatment was soaked in the surface treatment agent A1 at 25 degrees C. for 30 seconds such that the surface of the roller was soaked. Then, the roller surface was washed with ethyl acetate at 25 degrees C. for 30 seconds, and dried at 100 degrees C. for 10 minutes. Thus, a single-layered conductive roller of Example 2 was obtained.

### Example 3

The subject A2 of treatment was subjected to surface treatment in a same manner as Example 2 except that the surface treatment agent A2 was used instead of the surface treatment agent A1. Thus, a single-layered conductive roller of Example 3 was obtained.

### Comparative Example 5

The subject A2 of treatment, which was not subjected to surface treatment using a surface treatment agent, was defined as a single-layered conductive roller of Comparative example 5.

### Example 4

The subject A3 of treatment was subjected to surface treatment in a same manner as Example 2 except that the subject A3 was used. Thus, a single-layered conductive roller of Example 4 was obtained.

### Example 5

The subject A4 of treatment was soaked in the surface treatment agent A1 at 25 degrees C. for 30 seconds such that the surface of the roller was soaked. Then, the roller surface was washed with ethyl acetate at 25 degrees C. for 30 seconds, and dried at 100 degrees C. for 10 minutes. Thus, a double-layered conductive roller of Example 5 was obtained.

### Comparative Example 6

The subject A4 of treatment, which was not subjected to surface treatment using a surface treatment agent, was defined as a double-layered conductive roller of Comparative example 6.

### Comparative Example 7

The subject B1 of treatment was subjected to surface treatment in a same manner as Example 5 except that the subject B1 was used instead of the subject A4. Thus, a double-layered conductive roller of Comparative example 7 was obtained.

### Comparative Example 8

Instead of using the subject A4 of treatment, the subject A5 of treatment, which was not subjected to surface treatment using a surface treatment agent, was used and defined as a double-layered conductive roller of Comparative example 8.

### Example 6

The subject A6 of treatment was subjected to surface treatment in a same manner as Example 5 except that the subject A6 was used instead of the subject A4. Thus, a double-layered conductive roller of Example 6 was obtained.

### Example 7

The subject A7 of treatment was soaked in the surface treatment agent A1 at 25 degrees C. for 30 seconds such that the surface of the roller was soaked. Then, the roller surface was washed with ethyl acetate at 25 degrees C. for 30 seconds, and dried at 100 degrees C. for 10 minutes. Thus, a conductive belt of Example 7 was obtained.

### Example 8

The subject A7 of treatment was subjected to surface treatment in a same manner as Example 7 except that the surface treatment agent A3 was used instead of the surface treatment agent A1. Thus, a conductive belt of Example 8 was obtained.

### Comparative Example 9

The subject A7 of treatment, which was not subjected to surface treatment using a surface treatment agent, was defined as a conductive belt of Comparative example 9.

### Comparative Examples 10, 11

The subjects A7 of treatment were subjected to surface treatment in a same manner as Example 7 except that the surface treatment agents B1, B4 were used instead of the surface treatment agent A1. Thus, conductive belts of Comparative examples 10, 11 were obtained.

### Comparative Example 12

Instead of using the subject A7 of treatment, the subject A8 of treatment, which was not subjected to surface treatment using a surface treatment agent, was used and defined as a conductive belt of Comparative example 12.

Property evaluations of the produced conductive rollers and conductive belts were made. Measurement methods and evaluation procedures will be described below.

(Initial Coefficient of Friction)

Initial coefficients of frictions of surfaces of the conductive rollers and conductive belts were measured using a measurement instrument for coefficients of static/kinetic frictions (manuf.: KYOWA INTERFACE SCIENCE CO., LTD.) under the conditions of using an indenter of steel ball (3 mm in diameter) at the movement speed of 1 cm/second under the load of 100 g.

(Adhesion of Toner)

The conductive rollers and conductive belts were placed in a moist heat bath under the conditions of 50 degrees C. and a humidity of 95% for 1 week with their surfaces dusted uniformly with yellow toner of CANON LBP5050. Then, the conductive rollers and conductive belts were picked up from the bath to be cooled to room temperature, and air was blown on the surfaces of the conductive rollers and conductive belts. The conductive rollers and conductive belts on which all the toner was removed therefrom were regarded as “PASSED”. The conductive rollers and conductive belts on which some toner was left were regarded as “FAILED”.

(Coefficient of Friction after Adhesion Test)

The surfaces of the conductive rollers and conductive belts on which toner adhesion tests had been performed were wiped carefully with a non-woven fabric. Then, coefficients of frictions of the surfaces were measured under the conditions same as the measurement conditions of the initial coefficients of frictions.

(Toner Filming)

The conductive rollers were installed as development rollers in commercially available color printers (manuf.: HEWLETT-PACKARD JAPAN, LTD., “Color Laser Jet 4700dn). Then, a visual evaluation of the adhesion state of the toner adhering to each roller after printing 20,000 sheets of paper was performed. The conductive rollers to the surfaces of which no toner adhered were regarded as “PASSED”. The conductive rollers to the surfaces of which some toner adhered were regarded as “FAILED”.

(Crack)

The conductive belts were installed as intermediate transfer belts in commercially available full color digital complex copying machines (manuf.: KONICA MINOLTA BUSINESS TECHNOLOGIES, INC., “bizhab C550”). Then, image output (test pattern printing) was produced on 100,000 sheets of paper for each machine in the environment of 23.5 degrees C.×53% RH. Then, a visual evaluation of each belt surface was performed. The conductive belts that had no crack were regarded as “PASSED”. The conductive belts that had tiny cracks, which did not have detrimental effects on image quality, were regarded as “UNFAVORABLE”. The conductive belts that had such cracks as to have detrimental effects on image quality were regarded as “FAILED”.

TABLE 1

| | | Comparative | Comparative | Comparative | Comparative | | | Comparative | |
|---|---|---|---|---|---|---|---|---|---|
| | Example 1 | Example 1 | Example 2 | Example 3 | Example 4 | Example 2 | Example 3 | Example 5 | Example 4 |
| Configuration of member | Single-layered conductive roller | | | | | | | | |
| Configuration of subject | A1 | | | | | A2 | | | A3 |
| of treatment | | | | | | | | | |
| Type of surface treatment | A1 | — | B1 | B2 | B3 | A1 | A2 | — | A1 |
| agent | | | | | | | | | |
| Initial coefficient of | 0.2 | 0.6 | 0.4 | 0.2 | 0.4 | 0.2 | 0.2 | 1.3 | 0.1 |
| friction | | | | | | | | | |
| Adhesion of toner | PASSED | FAILED | PASSED | FAILED | PASSED | PASSED | PASSED | FAILED | EXCELLENT |
| Coefficient of friction | 0.2 | 1.0 | 0.5 | 0.9 | 0.5 | 0.2 | 0.2 | 1.4 | 0.1 |
| after adhesion test | | | | | | | | | |
| Filming | PASSED | FAILED | FAILED | FAILED | FAILED | PASSED | PASSED | FAILED | EXCELLENT |

TABLE 2

| | | Comparative | Comparative | Comparative | |
|---|---|---|---|---|---|
| | Example 5 | Example 6 | Example 7 | Example 8 | Example 6 |
| Configuration | Double-layered conductive roller | | | | |
| of member | | | | | |
| Configuration | A4 | A4 | B1 | A5 | A6 |
| of subject of | | | | | |
| treatment | | | | | |
| Type of surface | A1 | — | A1 | — | A1 |
| treatment agent | | | | | |
| Initial coefficient | 0.2 | 0.8 | 0.4 | 0.2 | 0.1 |
| of friction | | | | | |
| Adhesion of toner | PASSED | FAILED | FAILED | FAILED | EXCELLENT |
| Coefficient of | 0.2 | 1.2 | 0.8 | 0.5 | 0.1 |
| friction after | | | | | |
| adhesion test | | | | | |
| Filming | PASSED | FAILED | FAILED | FAILED | EXCELLENT |

TABLE 3

| | | | Comparative | Comparative | Comparative | Comparative |
|---|---|---|---|---|---|---|
| | Example 7 | Example 8 | Example 9 | Example 10 | Example 11 | Example 12 |
| Configuration of member | Conductive belt | | | | | |
| Configuration of subject of | A7 | | | | | A8 |
| treatment | | | | | | |
| Type of surface treatment | A1 | A3 | — | B1 | B4 | — |
| agent | | | | | | |
| Initial coefficient of friction | 0.4 | 0.7 | 1.9 | 1.2 | 0.8 | 0.3 |
| Adhesion of toner | PASSED | PASSED | FAILED | PASSED | PASSED | FAILED |
| Coefficient of friction after | 0.4 | 0.7 | 1.8 | 1.6 | 1.0 | 1 |
| adhesion test | | | | | | |
| Filming | PASSED | PASSED | FAILED | FAILED | UNFAVORABLE | FAILED |

In Example 1, the subject A1 that defined the single-layered conductive roller including the silicone rubber having the C—C bonds on its surface was subjected to the surface treatment using the surface treatment agent A1 containing the trichloroisocyanuric acid and the silicone oil containing the C═C bonds, so that the silicone groups were bonded to the surface of the roller via the isocyanuric acid backbones. It was found that the single-layered conductive roller of Example 1 had a low initial coefficient of friction and a low coefficient of friction after adhesion test, and had no adhesion of toner and no toner filming.

In contrast, in Comparative example 1, the subject A1 was not subjected to surface treatment using a surface treatment agent. In Comparative example 2, the subject A1 was subjected to the surface treatment using the surface treatment agent B1 that was made of only the isocyanuric acid except the solvents. In Comparative example 3, the subject A1 was subjected to the surface treatment using the surface treatment agent B2 that was made of only the silicone oil. In Comparative example 4, the subject A1 was subjected to the surface treatment using the surface treatment agent B3 containing the isocyanate. As a result, it was found that the single-layered conductive rollers of Comparative examples 1 to 4 had high initial coefficients of frictions and high coefficients of frictions after adhesion test, and had adhesion of toner and toner filming.

In Example 2, the subject A2 that defined the single-layered conductive roller including the NBR on its surface was subjected to the surface treatment using the surface treatment agent A2 in the same manner as Example 1. In Example 3, the subject A2 that defined the single-layered conductive roller was subjected to the surface treatment using the surface treatment agent A2 containing the trichloroisocyanuric acid, the silicone oil containing C═C bonds, and the butyl acrylate. Thus, it was found that the single-layered conductive rollers of Examples 2 and 3 had low initial coefficients of frictions and low coefficients of frictions after adhesion test, and had no adhesion of toner and no toner filming.

In Example 4, the subject A3 having convex portions was molded by using the molding die having the plurality of concave portions on its surface. Thus, it was found that the single-layered conductive roller of Example 4 had a low initial coefficient of friction and a low coefficient of friction after adhesion test, and had no adhesion of toner and no toner filming. In addition, it was found that the single-layered conductive roller of Example 4 had an excellent effect of reducing adhesion of toner and toner filming.

In contrast, in Comparative example 5, the subject A2 was not subjected to surface treatment using a surface treatment agent. As a result, it was found that the single-layered conductive roller of Comparative example 5 had a high initial coefficient of friction and a high coefficient of friction after adhesion test, and had adhesion of toner and toner filming.

In Example 5, the subject A4 that defined the double-layered conductive roller including the resin layer having the C═C bonds as its surface was subjected to the surface treatment using the surface treatment agent A1 in the same manner as Example 1. Thus, it was found that the double-layered conductive roller of Example 5 had a low initial coefficient of friction and a low coefficient of friction after adhesion test, and had no adhesion of toner and no toner filming as well as Example 1.

In Example 6, the subject A6 that defined the double-layered conductive roller having asperities on its surface, which was prepared by further adding the particles for forming surface roughness to the subject A4 including the resin layer having the C—C bonds as its surface, was subjected to the surface treatment using the surface treatment agent A1 in the same manner as Example 5. Thus, it was found that the double-layered conductive roller of Example 6 had a low initial coefficient of friction and a low coefficient of friction after adhesion test, and had no adhesion of toner and no toner filming as well as Example 5. In addition, it was found that the double-layered conductive roller of Example 6 had an excellent effect of reducing adhesion of toner and toner filming.

In contrast, in Comparative example 6, the subject A4 was not subjected to surface treatment using a surface treatment agent. In Comparative example 7, the subject B1 containing no C—C bonds was subjected to the surface treatment using the surface treatment agent A1. In Comparative example 8, the subject A5 contained the silicone oil containing C═C bonds instead of being subjected to surface treatment using the surface treatment agent A1 containing the silicone oil containing the C═C bonds. As a result, it was found that the double-layered conductive rollers of Comparative examples 6 to 8 had high initial coefficients of frictions and high coefficients of frictions after adhesion test, and had adhesion of toner and toner filming.

In Example 7, the subject A7 that defined the conductive belt including the elastic layer having the C═C bonds as its surface was subjected to the surface treatment using the surface treatment agent A1 in the same manner as Example 1. Thus, it was found that the conductive belt of Example 7 had a low initial coefficient of friction and a low coefficient of friction after adhesion test, and had no adhesion of toner and no toner filming as well as Example 1. In Example 8, the subject A7 that defined the conductive belt was subjected to the surface treatment using the surface treatment agent A2 containing the trichloroisocyanuric acid and the perfluorhexyl ethylene. Thus, it was found that the conductive belt of Example 8 had a low initial coefficient of friction and a low coefficient of friction after adhesion test, and had no adhesion of toner and no toner filming as well as Example 7.

In contrast, in Comparative example 9, the subject A7 that defined the conductive belt was not subjected to surface treatment using a surface treatment agent. In Comparative example 10, the subject A7 that defined the conductive belt was subjected to the surface treatment using the surface treatment agent B1 that was made of only the isocyanuric acid except the solvents. In Comparative example 11, the subject A7 that defined the conductive belt was subjected to the surface treatment using the surface treatment agent B4 that was made of the trichloroisocyanuric acid and the boron trifluoride-diethyl ether complex except the solvents. In Comparative example 12, the subject A8 contained the silicone oil containing C═C bonds instead of being subjected to the surface treatment using the surface treatment agent A1 containing the silicone oil containing the C═C bonds. As a result, it was found that the conductive belts of Comparative examples 9 to 12 had high initial coefficients of frictions and high coefficients of frictions after adhesion test, and had adhesion of toner and toner filming.

The foregoing description of the preferred embodiments of the present invention has been presented for purposes of illustration and description; however, it is not intended to be exhaustive or to limit the present invention to the precise form disclosed, and modifications and variations are possible as long as they do not deviate from the principles of the present invention.

For example, while the silicone groups are introduced as the specific functional groups as examples, functional groups other than the silicone groups can provide functions specific to the functional groups.

1. A modified polymer substrate, the substrate comprising:
a polymer substrate; and
an organic group having a functional group arranged to provide functions to a surface of the polymer substrate,
wherein the organic group is bonded to the surface of the polymer substrate via an isocyanuric acid backbone.

2. The modified polymer substrate according to claim 1, wherein the functional group comprises one or more than one kind of functional group selected from the group consisting of a silicone group, a fluorine-containing group, a perfluoroalkyl group, an ester group, an amide group, an imide group, an ether group, an aryl group, an azo group, a diazo group, a nitro group, an epoxy group, a carbonyl group, a heterocyclic group, a mesoionic group, a halogen group, an amino group, an imino group, an alkyl group, a sulfonic acid group, a hydroxyl group, an acyl group, a formyl group, a carboxylic acid group, a urea group, a urethane group, and a cyano group.

3. The modified polymer substrate according to claim 2, wherein the organic group comprises a group originated in an organic compound having an unsaturated carbon-to-carbon double bond.

4. The modified polymer substrate according to claim 3, wherein the surface of the polymer substrate has asperities.

5. (canceled)

6. (canceled)

7. The modified polymer substrate according to claim 2, wherein the surface of the polymer substrate has asperities.

8. The modified polymer substrate according to claim 1, wherein the organic group comprises a group originated in an organic compound having an unsaturated carbon-to-carbon double bond.

9. The modified polymer substrate according to claim 8, wherein the surface of the polymer substrate has asperities.

10. The modified polymer substrate according to claim 1, wherein the surface of the polymer substrate has asperities.

11. A method for producing a modified polymer substrate, the method comprising the step of bringing a treatment solvent into contact with a surface of a polymer substrate containing an organic component having unsaturated carbon-to-carbon double bonds, wherein the treatment solvent contains:
a component (a) that defines a trichloroisocyanuric acid; and
a component (b) that defines a compound that has:
an unsaturated carbon-to-carbon double bond; and
an organic group having a functional group arranged to provide functions to the surface of the polymer substrate.

12. A surface treatment agent that is brought into contact with a surface of a polymer substrate containing an organic component having unsaturated carbon-to-carbon double bonds, the surface treatment agent containing:
a component (a) that defines a trichloroisocyanuric acid; and
a component (b) that defines a compound that has:
an unsaturated carbon-to-carbon double bond; and
an organic group having a functional group arranged to provide functions to the surface of the polymer substrate.
